(19) United States
(12) Patent Application Publication
(10) Pub. No.: US 2025/0050969 A1
(43) Pub. Date: Feb. 13, 2025

(54) BICYCLE DRIVETRAIN SYSTEM, BICYCLE DRIVETRAIN, METHOD, AND USE

(71) Applicant: CLASSIFIED CYCLING B.V., Antwerpen (BE)

(72) Inventor: Roëll Marie VAN DRUTEN, Eindhoven (NL)

(21) Appl. No.: 18/717,212

(22) PCT Filed: Dec. 8, 2022
(86) PCT No.: PCT/EP2022/085046

§ 371 Date: Jun. 6, 2024

(30) Foreign Application Priority Data
Dec. 8, 2021 (NL) 2030082

(51) Int. Cl. B62M 9/121; B62M 11/14

(52) U.S. Cl. CPC B62M 9/121; B62M 11/14

(57) ABSTRACT

A bicycle drivetrain (3) system for a road bicycle (2), comprising: a transmission assembly (14) having at least two selectable transmission ratios, a single chainring (9) having chainring teeth (10) for engagement with the bicycle chain (7), the chainring teeth (10) being arranged along a chainring (9) circumference, and a cogset (4) comprising a plurality of sprockets (5) each having respective sprocket teeth (6) for engagement with a bicycle chain (7) which defines a minimal interteeth distance, the sprocket teeth (6) being arranged along a respective sprocket (5) circumference, wherein a smallest respective sprocket (5) circumference of any such sprocket (5) of the cogset (4) corresponds to at least twelve times the minimal interteeth distance.

### FIELD OF THE INVENTION

The invention relates to a bicycle drivetrain system for a road bicycle. The invention further relates to a bicycle drivetrain comprising the bicycle drivetrain system, to a method of modifying a drivetrain of a bicycle, and to use of the bicycle drivetrain system.

### BACKGROUND TO THE INVENTION

Road bicycles are generally designed for use on paved or otherwise relatively even surfaces, such as roads. Bicycle drivetrain systems are known for use in bicycle drivetrains of road bicycles. Known bicycle drivetrain systems comprise a cogset, generally for attachment to a wheel hub and comprising one or more sprockets, and a crankset, generally for attachment to pedals and comprising one or more chainrings. A bicycle chain can couple a chainring of the crankset to a sprocket of the cogset for power transmission from the pedals to the wheel.

Depending on the sizes of the used chainring and sprocket, a particular gear ratio may be provided. For example, a combination of a large chainring and a small sprocket results in a high gear ratio, and thus in a large amount of wheel revolution per unit of pedal revolution. Conversely, a combination of a small chainring and a large sprocket results in a low gear ratio, and thus in a small amount of wheel revolution per unit of pedal revolution. In a bicycle drivetrain system, a range of different sprocket sizes and/or different chainring sizes can be provided to enable a rider to configure a desired gear ratio. Thus, at a same or similar general pedaling frequency or cadence, a rider can choose to ride the bicycle faster with more pedaling force, or alternatively slower with less pedaling force.

Where different sprocket sizes are combined in a single cogset, and/or different chainring sizes are combined in a single crankset, the rider can advantageously switch between different gear ratios while riding the bicycle, for example using a gear change mechanism which can transfer the bicycle chain between different sprockets and/or between different chainrings. Road bicycle riders generally prefer that a bicycle drivetrain provides a large range of selectable gear ratios, in particular with relatively small differences between subsequent gear ratios, thus a large total number of gear ratios. In this way, the rider can advantageously adjust the gear ratio in a relatively fine way, for example depending on the riding conditions. Meanwhile, riders increasingly prefer to have relatively high gear ratios available, enabling them to achieve high speeds. Accordingly, there has been a trend to provide cogsets with an increasing number of differently sized sprockets, in particular with increasingly small sprockets, going as small as 10-tooth sprockets, 9-tooth sprockets and even 8-tooth sprockets.

### SUMMARY OF THE INVENTION

An object of the invention is to support riders of road bicycles in achieving higher speeds with a similar pedaling effort, or similarly high speeds with less pedaling effort. An object is to provide higher efficiency in a bicycle drivetrain, in particular at high gear ratios. An object is to at least provide an alternative bicycle drivetrain system for a road bicycle.

An aspect of the invention provides a bicycle drivetrain system for a road bicycle. The bicycle drivetrain comprises a transmission assembly having at least two selectable transmission ratios. Further, the bicycle drivetrain system comprises a cogset comprising a plurality of sprockets each having respective sprocket teeth for engagement with a bicycle chain. The cogset can be mounted to drive an input of the hub gear assembly. The bicycle chain defines a minimal interteeth distance. The sprocket teeth are arranged along a respective sprocket circumference. A smallest respective sprocket circumference of any such sprocket of the cogset corresponds to at least twelve times the minimal interteeth distance. The bicycle drivetrain system further comprises a single chainring, i.e. only one chainring, having chainring teeth for engagement with the bicycle chain. The chainring teeth are arranged along a chainring circumference. The single chainring can be mounted to drive a selected sprocket of the cogset via the bicycle chain. The transmission assembly can be mounted to be driven by the cogset. Alternatively, or additionally, the transmission assembly can be mounted to drive the chainring.

The transmission assembly can be a hub gear assembly. The transmission assembly can be a crank gear assembly.

The a transmission assembly can complement gear ratios provided by the cogset and the single chainring. In this way, a range of available gear ratios can advantageously be extended, in particular without disproportionally sacrificing drivetrain efficiency. The transmission assembly can be arranged for shifting from one transmission ratio to another transmission ratio under load. The transmission assembly can e.g. be as described in WO2018/199757A2, incorporated herein by reference.

The transmission assembly can be a hub gear assembly. The transmission assembly can be a crank gear assembly.

Optionally, the transmission assembly comprises a planetary gear set. The transmission assembly can include a speed reducing transmission ratio, e.g. in combination with a unity transmission ratio. The transmission assembly can include a speed increasing transmission ratio, e.g. in combination with a unity transmission ratio. The transmission assembly can include three selectable transmission ratios, such as a speed reducing transmission ratio, a unity transmission ratio, and a speed increasing transmission ratio. This can apply to the transmission assembly configured as hub gear assembly as well as to the transmission assembly configured as crank gear assembly.

Optionally, the transmission assembly includes a continuously variable transmission, CVT. The CVT can be configured to be operated at two or more different discrete transmission ratios.

For the single chainring the respective chainring circumference can correspond to at least 58 times the minimal interteeth distance.

Preferably, the single chain ring has a chainring circumference corresponding to an even multiple of the minimal interteeth distance. Optionally, even teeth of the chainring have a different axial width than odd teeth of the chainring. This may aid in maintaining the chain properly positioned on the single chainring.

Advantageously, the smallest respective sprocket circumference of at least twelve times the minimal interteeth distance enables a relatively high power transfer efficiency between the bicycle chain and the cogset, in particular at a highest gear ratio of the drivetrain system. In this respect, it has been found that smaller sprocket sizes, as provided in known drivetrain systems, tend to negatively affect such efficiency. Meanwhile, the chainring circumference of at least 58 times the minimal interteeth distance and/or the transmission assembly enables that a relatively high gear ratio can still be chosen by the rider, thereby allowing the rider to achieve, if and when desired, high speeds at a normal, in particular efficient, pedaling frequency or cadence. Thus, a higher overall efficiency is provided, in particular at high gear ratios. Meanwhile, a rider can confidently and conveniently select a high, for example highest, gear ratio, without thereby risking an excessive penalty on the required pedaling force. These effects, already by themselves but particularly together, advantageously support a road bicycle rider in achieving higher speeds with a similar pedaling effort, or similarly high speeds with less pedaling effort.

In the present context, the minimal interteeth distance defined by the bicycle chain can generally be understood as a pitch of the bicycle chain, which corresponds to a smallest possible pitch of the teeth of an associated sprocket or chainring. Thus, for example, if a sprocket circumference corresponds to twelve times the minimal interteeth distance, the respective sprocket can have at most twelve teeth distributed along its circumference. Similarly, if a chainring circumference corresponds to 58 times the minimal interteeth distance, the respective chainring can have at most 58 teeth distributed along its circumference. Meanwhile, it shall be appreciated that such a sprocket or chainring can optionally have less teeth along a same circumference, for example half of the maximum number of teeth, as will be explained further elsewhere herein.

The bicycle drivetrain system may comprise the aforementioned bicycle chain, in particular for coupling the single chainring to a sprocket of the cogset. The bicycle chain may be one that is known as such, and/or a bicycle chain with one or more standard dimensions, in particular a standard bicycle chain pitch and/or a standard bicycle chain link length.

Optionally, the smallest respective sprocket circumference of any such sprocket of the cogset corresponds to more than twelve times the minimal interteeth distance, for example 13, 14, 15, or 16 times the minimal interteeth distance. Aforementioned advantages can thereby be provided to a greater degree and/or in an alternative way.

Optionally, the single chainring has a chainring circumference corresponding to more than 58 times the minimal interteeth distance, for example 60 or 66 times the minimal interteeth distance. Aforementioned advantages can thereby be provided to a greater degree and/or in an alternative way.

Optionally, the bicycle drivetrain system is configured to provide, at least selectively, a largest gear ratio from the crankset to the cogset of at least 4.83, for example about 5 or more. The gear ratio of 4.83 can e.g. correspond to a chainring circumference corresponding to 58 times the minimal interteeth distance, combined with a sprocket circumference corresponding to twelve times the minimal interteeth distance and a transmission assembly at unity transmission ratio. In this way, a rider can ride a road bicycle at a relatively high gear ratio, and can thereby achieve relatively high speeds at an efficient cadence.

Optionally, the bicycle drivetrain system is configured to provide, at least selectively, a smallest gear ratio from the crankset to the cogset of at most 2.1. A gear ratio of 2.07 can e.g. correspond to a chainring circumference corresponding to 58 times the minimal interteeth distance, combined with a sprocket circumference corresponding to 28 times the minimal interteeth distance. In this way, a rider can ride a road bicycle at a relatively low gear ratio, in particular selectively for a desired period of time, for example to accelerate from stance, during strong head winds, or when riding uphill.

Optionally, the bicycle drivetrain system is configured to provide a range of selectable gear ratios from the chainring to the cogset and via the transmission assembly, the range having an upper limit of less than 6, preferably less than 5.5, for example about 5. In this way, a rider can be supported in avoiding excessively high gear ratios and/or maintaining a relatively high drivetrain efficiency. Also, such a gear ratio upper limit can enable a relatively compact and robust drivetrain.

Optionally, the bicycle drivetrain system is configured to provide a range of selectable gear ratios from the chainring to the cogset and via the transmission assembly, the range having a lower limit of more than 1, preferably more than 1.5, for example about 2. In this way, a rider can be supported in avoiding excessively low gear ratios. Also, such a gear ratio lower limit can enable a relatively compact and robust drivetrain.

Optionally, the cogset is arranged to provide a range of gear ratios of less than 300%. A gear ratio range of 283% can e.g. correspond to a largest sprocket circumference corresponding to 34 times the minimal interteeth distance, and a smallest sprocket circumference corresponding to 12 times the minimal interteeth distance.

Optionally, an axial distance between a centerline of the chainring and a centerline of the bicycle frame is larger than 49 mm, preferably more than 51 mm, more preferably more than 52 mm.

Optionally, a mutual interspacing of subsequent ones of the respective chainring teeth along the chainring circumference corresponds to an integer multiple of the minimal interteeth distance, for example double the minimal interteeth distance, preferably along the entire chainring circumference. Optionally, a mutual interspacing of subsequent ones of the respective chainring teeth along the chainring circumference corresponds to an integer multiple of the minimal interteeth distance, for example double the minimal interteeth distance, for only a part of the chainring circumference. As alluded to above, the number of chainring teeth may thus be less than a maximum which corresponds to the chainring circumference. It has been found that, advantageously, such a reduced, e.g. halved, number of chainring teeth can provide a more efficient power transfer from the chainring to the bicycle chain, thereby promoting a higher overall efficiency of the drivetrain.

Optionally, for at least one sprocket of the plurality of sprockets of the cogset, a mutual interspacing of subsequent ones of the respective sprocket teeth along the sprocket circumference corresponds to an integer multiple of the minimal interteeth distance, for example double the minimal interteeth distance, preferably along the entire sprocket circumference. Optionally, for at least one sprocket of the plurality of sprockets of the cogset, a mutual interspacing of subsequent ones of the respective sprocket teeth along the sprocket circumference corresponds to an integer multiple of the minimal interteeth distance, for example double the minimal interteeth distance, for only a part of the chainring circumference. As alluded to above, the number of sprocket teeth may thus be less than a maximum which corresponds to the sprocket circumference. It has been found that, advantageously, such a reduced, e.g. halved, number of sprocket teeth can provide a more efficient power transfer from the bicycle chain to the sprocket, thereby promoting a higher overall efficiency of the drivetrain.

Optionally, the cogset is free from any sprocket having less than twelve respective sprocket teeth, so that each sprocket of the plurality of sprockets of the cogset has at least twelve respective sprocket teeth. It has been found that, by thus avoiding sprockets with less than twelve teeth, it can be promoted that power transfer from the bicycle chain to the cogset remains relatively efficient substantially regardless of which sprocket of the cogset is selected.

Optionally, the plurality of sprockets of the cogset together define an axial range for the bicycle chain at the cogset, said axial range being less than or equal to 36 mm, preferably less than or equal to 30 mm, more preferably less than or equal to 25 mm. In this way, lateral bending or twisting of the bicycle chain can be limited, which can advantageously promote efficient power transfer via the bicycle chain.

Optionally, the number of sprockets of the plurality of sprockets of the cogset is less than or equal to ten, preferably less than or equal to nine, more preferably less than or equal to 8. Such a limited number of sprockets enables that each sprocket can have a sufficient axial width while a total axial width of the cogset can be relatively small, in particular to provide a relatively small axial range for the bicycle chain at the cogset.

Optionally, the number of sprockets of the plurality of sprockets of the cogset is less than or equal to ten and the axial spacing between the cogs is less than 3.7 mm, preferably less than 3.6 mm, more preferably less than 3.5 mm.

Optionally, the bicycle drivetrain system further comprises at least one gear change mechanism. The gear change mechanism enables a rider to change gears, and thus possibly gear ratios, relatively easily, in particular while riding the bicycle. The gear change mechanism can be realized in various ways.

Optionally, the at least one gear change mechanism comprises a movable chain guide which is operable to transfer the bicycle chain between different sprockets of the cogset.

Optionally, the at least one gear change mechanism comprises a spring to tension the chain and a friction mechanism that at least in one direction dampens the spring movement.

The movable chain guide can for example be a movable chain guide which is known as such for road bicycles. When applied in a drivetrain system according to the present invention, a movable chain guide can advantageously enable gear changes while riding.

Optionally, the at least one gear change mechanism comprises a derailleur assembly, such as a clutch derailleur assembly. A clutch derailleur assembly can advantageously maintain tension in the bicycle chain, which in turn can further promote efficient power transfer in the drivetrain. As an example, the clutch derailleur assembly can be one that is known as such for bicycles.

Optionally, the at least one gear change mechanism comprises an electronic gear change device. The electronic gear change device can be configured for changing a transmission ratio of the transmission assembly and/or selecting a sprocket of the cogset. The electronic gear change device can include an electronic derailleur gear change device. An electronic gear change device can advantageously make changing gear faster and/or more efficient, thereby further promoting an overall riding efficiency. The electronic gear change device can be one that is known as such for bicycles.

Optionally, the chainring forms a, substantially, closed surface from the spindle towards the teeth. Hence, the chainring together with the spindle, and optionally the crank arm, forms a, substantially, closed surface. The substantially closed surface is considered substantially closed if more than 90% of the surface area within the chainring perimeter, preferably more than 95%, more preferably more than 98%, is closed.

Optionally, the closed surface is arranged to be personalized. The closed surface can e.g. be personalized by a user, buyer, seller, etc. The personalization can e.g. be a color, pattern, image, photograph, fabric or the like, e.g. matching the bicycle frame, a user's clothing or the like.

Optionally, the closed surface can be removed from the spindle without disassembling the crank-arms. Hence, the closed surface can easily be removed. Optionally, the bicycle drivetrain system comprises a cover covering the closed surface. Optionally the cover can be removed without disassembling the chainring. Alternatively, the bicycle drivetrain system comprises a cover covering the chainring, such that the cover forms a, substantially, closed surface.

A further aspect provides a bicycle drivetrain comprising the bicycle drivetrain system with bicycle chain described herein, wherein the bicycle chain is engaged with one of the sprockets of the cogset as well as with the chainring. Such a bicycle drivetrain provides above mentioned advantages.

A further aspect provides a bicycle, in particular a road bicycle, comprising the bicycle drivetrain system described herein and/or the bicycle drivetrain described herein. Such a bicycle provides above mentioned advantages.

A further aspect provides a method of modifying a drivetrain of a bicycle. The method comprises replacing a cogset and/or a crankset of the drivetrain. If the drivetrain to be modified comprises a first cogset which comprises at least one sprocket whose sprocket circumference corresponds to less than twelve times a minimal interteeth distance defined by a bicycle chain of the drivetrain, the method comprises replacing the first cogset by a second cogset. The second cogset comprises a plurality of sprockets, wherein a smallest respective sprocket circumference of any sprocket of the second cogset corresponds to at least twelve times the minimal interteeth distance. If the drivetrain to be modified comprises a first crankset which is free from any chainring whose chainring circumference corresponds to at least 58 times the minimal interteeth distance, the method comprises replacing the first crankset by a single chainring. The single chainring has chainring circumference corresponding to at least 58 times the minimal interteeth distance. Such a method provides above mentioned advantages, in particular with relatively little effort and/or cost in case a bicycle is already available.

A further aspect provides a use of a bicycle drivetrain system as described herein in a bicycle drive train, in particular of a road bicycle. Such use provides above mentioned advantages.

It will be appreciated that all features and options mentioned in view of the method apply equally to the system and use, and vice versa. It will also be clear that any one or more of the above aspects, features and options can be combined.

### BRIEF DESCRIPTION OF THE DRAWING

In the following detailed description, the invention will be explained using exemplary embodiments which are shown in the drawing. The drawing is schematic, thus not necessarily drawn to scale, and merely shows examples. In particular, any absolute dimensions indicated therein are merely exemplary. In the drawing, corresponding elements have been provided with corresponding reference signs. In the drawing:

FIG. 1 shows a side view of a road bicycle;

FIG. 2 shows a side view of a bicycle drivetrain;

FIG. 3 shows a partly opened cross sectional top view of a bicycle drivetrain with an associated section of a bicycle frame;

FIG. 4 shows a partly opened cross sectional top view of a bicycle drivetrain with an associated section of a bicycle frame;

FIGS. 5A-5D show examples of axle assemblies;

FIG. 6A shows a side view of a sprocket with a section of a bicycle chain;

FIG. 6B shows a side view of an alternative sprocket with the section of the bicycle chain;

FIG. 7A shows a side view of a chainring with the section of the bicycle chain; and

FIG. 7B shows a side view of an alternative chainring with the section of the bicycle chain.

### DETAILED DESCRIPTION

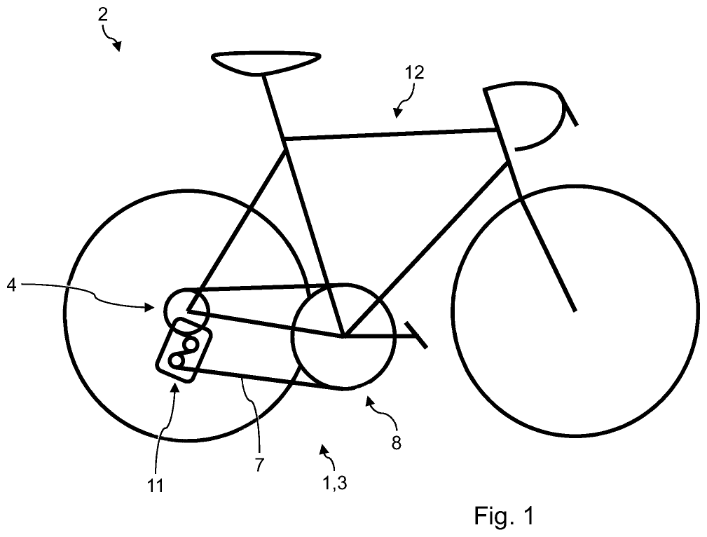

FIGS. 1-4 variously show a bicycle drivetrain system 1 for a road bicycle 2, in particular in a bicycle drivetrain 3 of the road bicycle 2. FIGS. 1-4 also variously illustrate a use of the bicycle drivetrain system 1 in a bicycle drive train 3, in particular of a road bicycle 2. FIG. 1 shows a bicycle, in particular a road bicycle 2, comprising such a bicycle drivetrain system 1 and/or such a bicycle drivetrain 3.

The bicycle drivetrain system 1 comprises a cogset 4 comprising a plurality of sprockets 5 each having respective sprocket teeth 6 for engagement with a bicycle chain 7. The bicycle chain 7 defines a minimal interteeth distance D. The sprocket teeth 6 are arranged along a respective sprocket circumference S of the respective sprocket 5. A smallest respective sprocket circumference S of any such sprocket 5 of the cogset 4 corresponds to at least twelve times the minimal interteeth distance D.

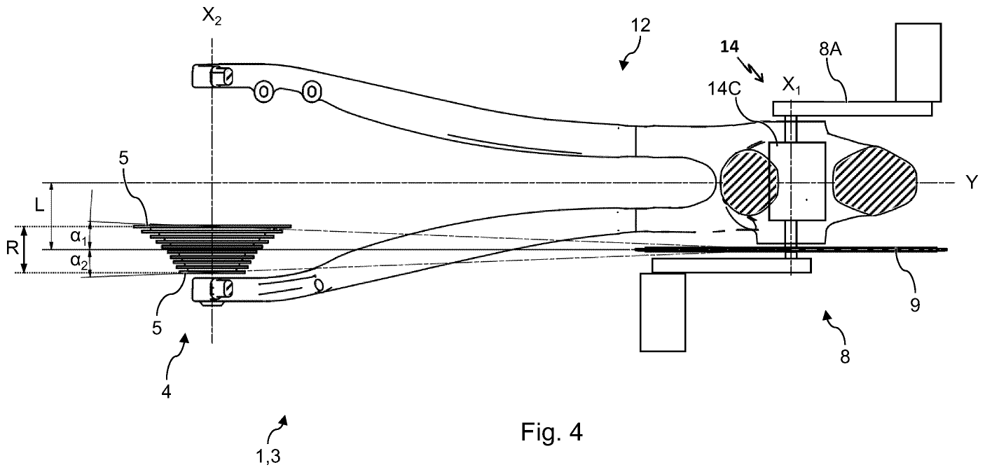

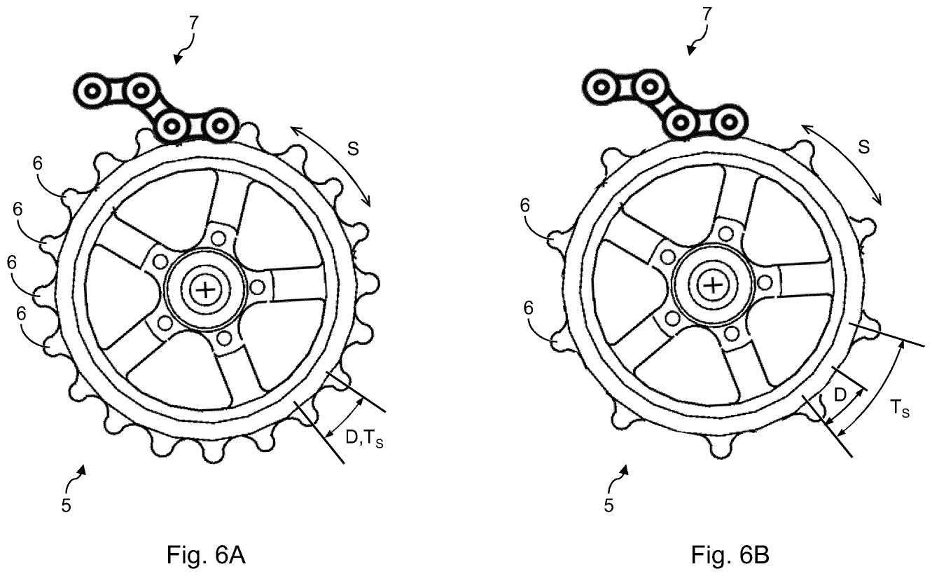

FIG. 6A shows a single exemplary sprocket 5 along with a section of bicycle chain 7 partly engaged with the sprocket 5, thereby obscuring one of the sprocket teeth 6. In this example, it can be seen that the number of sprocket teeth 6 is 20, of which only four have been provided with a reference sign 6, for clarity of the drawing. It can also be seen that the sprocket circumference S here corresponds to 20 times the minimal interteeth distance D as determined by the bicycle chain 7, so that an interspacing Ts of the sprocket teeth 6 here corresponds to the minimal interteeth distance D In an alternative exemplary sprocket 5, shown in FIG. 4B, the number of teeth 6 is halved and their interspacing Ts is doubled, while the sprocket circumference S still corresponds to 20 times the minimal interteeth distance D. It shall be appreciated that similar definitions and/or configurations are possible for sprockets having different sprocket circumferences, for example a sprocket circumference corresponding to twelve times the minimal interteeth distance D.

Optionally, the number of sprockets 5 of the plurality of sprockets 5 of the cogset 4 is less than or equal to ten.

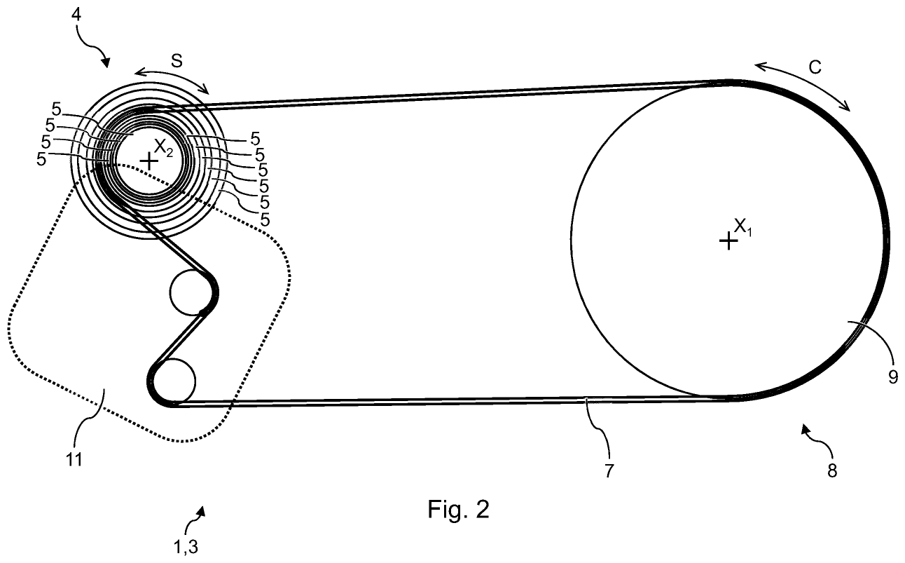

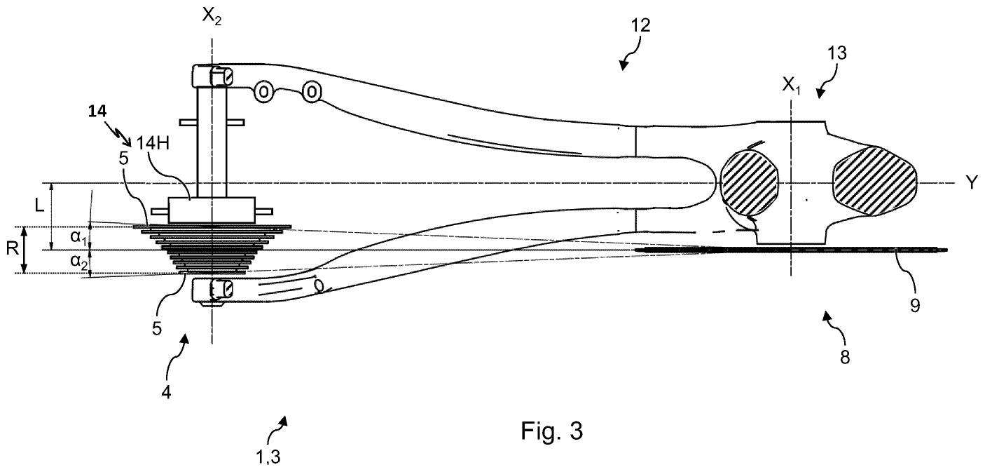

In FIG. 2 it can be seen that the cogset 4 here comprises ten sprockets 5 each having a different sprocket circumference S. A corresponding cogset 4 is shown from above in FIGS. 3 and 4, wherein for clarity of the drawing only two outermost sprockets 5 of the ten sprockets 5 have been provided with a reference sign.

The bicycle drivetrain system 1 further comprises a crank assembly 8 comprising a single chainring 9 having respective chainring teeth 10 for engagement with the bicycle chain 7. The chainring teeth 10 are arranged along a respective chainring circumference C of the chainring 9. The chainring circumference C of the single chainring 9 corresponds, in this example to at least 58 times the minimal interteeth distance D.

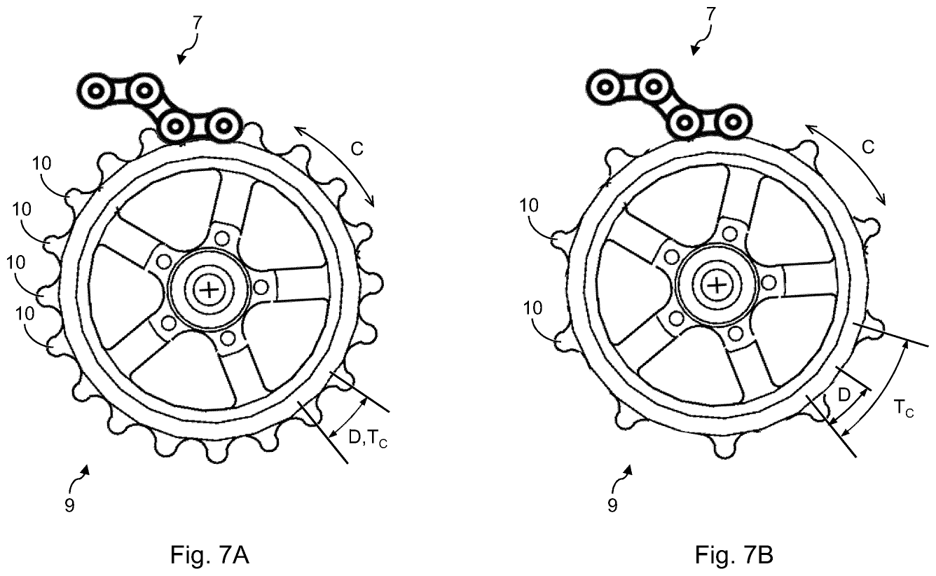

FIG. 7A shows a single exemplary chainring 9 along with a section of bicycle chain 7 partly engaged with the chainring 9, thereby obscuring one of the chainring teeth 10. In this example, it can be seen that the number of chainring teeth 10 is 20 for clarity of the drawing, of which only four have been provided with a reference sign 10, for clarity of the drawing. It can also be seen that the chainring circumference C here corresponds to 20 times the minimal interteeth distance D as determined by the bicycle chain 7, so that an interspacing Tc of the chainring teeth 10 here corresponds to the minimal interteeth distance D In an alternative exemplary chainring 9, shown in FIG. 6B, the number of teeth 10 is halved and their interspacing Tc is doubled, while the chainring circumference C still corresponds to 20 times the minimal interteeth distance D. It shall be appreciated that similar definitions and/or configurations are possible for chainrings having different chainring circumferences, for example a chainring circumference corresponding to 58 or more times the minimal interteeth distance D.

The bicycle drivetrain system 1 further comprises a transmission assembly 14 having at least two selectable transmission ratios.

In the example of FIG. 3 the transmission assembly is configured as a hub gear assembly 14H. The cogset 4 is coupled to the hub gear assembly 14H such that when the chain 7 drives one of the sprockets 5 of the cogset 4, the cogset 4 drives the hub gear assembly 14.

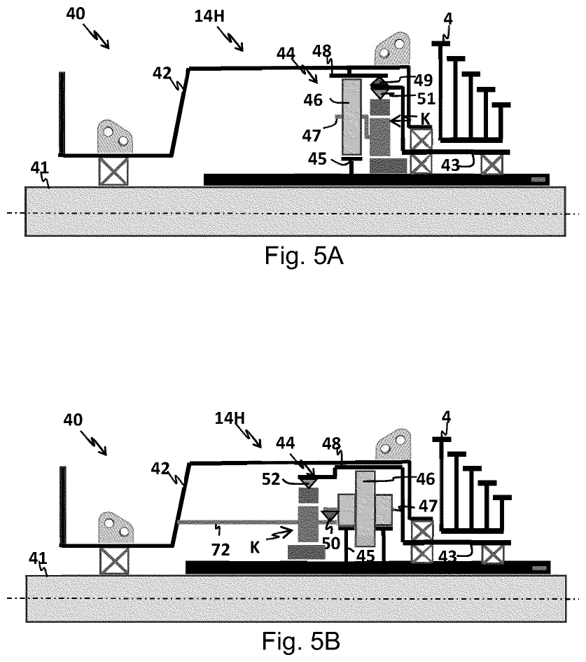

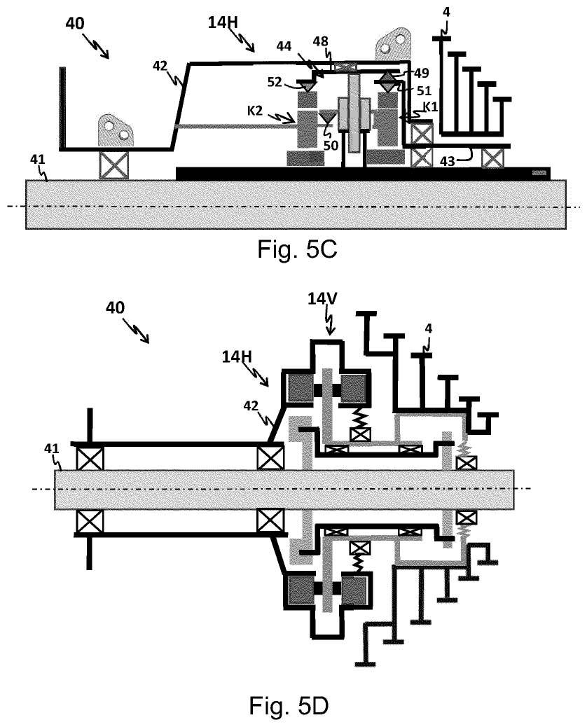

FIGS. 5A-5D show examples of axle assemblies 40. The axle assembly includes a cogset 4 and a hub gear assembly 14H. The axle assembly includes an axle 41. The axle can be mounted non-rotatably relative to the frame of the bicycle. A hub shell 42 is rotatably mounted on the axle 41. A driver 43 is rotatably mounted on the axle 41. The cogset 4 is, here detachably, mounted to the driver 43. The driver 43 can be detachably fixed to an input of the hub gear assembly 14H. An output of the hub gear assembly is fixed to the hub shell 42 for driving the hub shell in rotation.

The transmission assembly 14 is arranged for selectively being operated according to two or more different transmission ratios. In this example, the hub gear assembly 14H includes a planetary gear set 44. The planetary gear set 44 includes a sun gear 45, one or more planet gears 46 carried by a planet carrier 47 and a ring gear 48. In the example of FIGS. 5B and 5C the planet gear 46 is a stepped planet gear 46, although it will be appreciated that also singular non-stepped planet gears can be used as shown in FIG. 5A. The stepped planet gear 46 comprises a large-radius part and a small-radius part. Here, the small-radius part meshes with the sun gear 45, while the large-radius part meshes with the gear 48. In this example, each stepped planet gear 46 particularly includes two small-radius parts arranged on either side of the large-radius part, to obtain a substantially symmetric planet gear 46. Here the sun gear 45 is split into two sun gear parts to mesh with the two small-radius parts.

The hub gear assembly 14H further comprises a clutch K. In the example of FIG. 5C the hub gear assembly includes two clutches K1, K2. The clutch K or clutches K1, K2 may for example be similar or identical to a clutch as described in WO1018/199757A2, WO1020/085911A2, or WO1021/080431A1, incorporated herein by reference in their entirety. The hub gear assembly 14H further includes one or more freewheel clutches 49, 50, 51, 52. The clutch or clutches can be electronically actuated, e.g. wired or wirelessly.

In the example of FIG. 5A, the ring gear 49 is fixed to the hub shell 42. The clutch K allows torque from the driver 43 to be selectively coupled to the carrier 47 via the clutch K or to the ring gear 49 via the freewheel clutch 49. The hub gear assembly 14H of FIG. 5A can selectively be operated in a unity transmission ratio or a speed increasing transmission ratio.

In the example of FIG. 5B, clutch K allows torque from the driver 43 to be selectively coupled to the hub shell 42 from the ring gear 48 via the clutch K or from the carrier 47 via the freewheel clutch 50. The hub gear assembly 14 of FIG. 5B can selectively be operated in a unity transmission ratio or a speed decreasing transmission ratio.

In the example of FIG. 5C, The clutch K1 allows torque from the driver 43 to be selectively coupled to the carrier 47 via the clutch K1 or to the ring gear 49 via the freewheel clutch 49. Also, clutch K2 allows torque from the ring gear 48 to be selectively coupled to the hub shell 42 via the clutch K2 or from the carrier 47 via the freewheel clutch 50. The hub gear assembly 14 of FIG. 5C can selectively be operated in a speed decreasing transmission ratio, a unity transmission ratio, or a speed increasing transmission ratio.

In the example of FIG. 5D the hub gear assembly includes a continuously variable transmission, CVT, 14V. The continuously variable transmission 14V has an input coupled to the cogset 4 and an output coupled to the hub shell 42. In this example, the CVT is of the ratcheting type. The CVT can e.g. be of the type described in WO2022/248136A2, incorporated herein by reference in its entirety. The CVT can be configured to be operated according to two or more discrete transmission ratios.

In the example of FIG. 4 the transmission assembly is configured as a crank gear assembly 14C. An input of the crank gear assembly 14C is in this example coupled to cranks 8A. The input can also be coupled to an electric motor. An output of the crank gear assembly 14C is coupled to the chainring 9 to drive the chainring. The crank gear assembly 14C is arranged for selectively being operated according to two or more different transmission ratios. The crank gear assembly 14C can e.g. comprise a planetary gear set 44 as shown in FIGS. 5A-5C. An input of the planetary gear set 44 can be coupled to the crank, or a crank axle. An output of the planetary gear set can be coupled to the chainring 9. The crank gear assembly 14C can include a CVT, e.g. as shown in FIG. 5C, or of the type described in WO2022/248136A2.

It will be appreciated that the drivetrain system may include both the hub gear assembly and the crank gear assembly. The hub gear assembly can include a planetary gear set and/or a CVT, and the crank gear assembly can include a planetary gear set and/or a CVT.

In use, the crankset 8 is generally positioned at a bottom bracket 13 (see FIG. 3) of a frame 12 of the bicycle 2, in particular being rotatable about an associated bottom bracket axis X₁. Meanwhile, the cogset 4 is generally positioned at a rear wheel of the bicycle 2, in particular being rotatable about an associated rear wheel axis X₂.

In the shown examples, the bicycle drivetrain system 1 and/or the bicycle drivetrain 3 comprises the aforementioned bicycle chain 7, in particular engaged with a chainring 9 and with a sprocket 5 of the cogset 4 to provide a mechanical coupling therebetween for power transfer from the crankset 8 to the cogset 4. The bicycle chain 7 is preferably a standard type bicycle chain, in particular one determining a standard minimal interteeth distance D for the sprockets 5 and the at least one chainring 9.

For clarity of the drawing, individual links of the bicycle chain 7 are not shown in FIGS. 1 and 2, and the bicycle chain 7 is not shown in FIG. 3. In FIGS. 5A-B and 6A-B, only a section of such a bicycle chain 7 is shown.

Optionally, the smallest respective sprocket circumference S of any such sprocket 5 of the cogset 4 corresponds to more than twelve times the minimal interteeth distance D, for example 13, 14, 15 or 16 times the minimal interteeth distance D.

Optionally, the chainring 9 has a chainring circumference C corresponds to more than 58 times the minimal interteeth distance D, for example 60 or 66 times the minimal interteeth distance D. It will be appreciated that if the transmission assembly 14 includes a speed-increasing transmission ratio, the chainring circumference C may be chosen smaller than 58 times the minimal interteeth distance D, and/or the smallest sprocket circumference S may be chosen larger than than twelve times the minimal interteeth distance D.

Optionally, the bicycle drivetrain system 1 is configured to provide, at least selectively, a largest gear ratio from the chainring 9 via the cogset 4 and the transmission assembly 14 of at least 4.5, for example about 5 or more.

For example, a gear ratio of about 4.83 can be provided by a combination of a chainring circumference C of 58 times the minimal interteeth distance D, a sprocket circumference S of twelve times the minimal interteeth distance D, and a transmission assembly transmission ratio of unity. For example, a gear ratio of 5 can be provided by a combination of a chainring circumference C of 60 times the minimal interteeth distance D, a sprocket circumference S of twelve times the minimal interteeth distance D, and a transmission assembly transmission ratio of unity. For example, a gear ratio of about 5.08 can be provided by a combination of a chainring circumference C of 66 times the minimal interteeth distance D, a sprocket circumference S of thirteen times the minimal interteeth distance D, and a transmission assembly transmission ratio of unity. For example, a gear ratio of about 5.25 can be provided by a combination of a chainring circumference C of 58 times the minimal interteeth distance D, a sprocket circumference S of sixteen times the minimal interteeth distance D, and a transmission assembly transmission ratio of 1.45. For example, a gear ratio of about 4.89 can be provided by a combination of a chainring circumference C of 54 times the minimal interteeth distance D, a sprocket circumference S of sixteen times the minimal interteeth distance D, and a transmission assembly transmission ratio of 1.45.

Preferably, the single chainring has a circumference C corresponding to an even multiple of the minimal interteeth distance D. The single chainring can have an even number of teeth. Optionally, even teeth of the chainring have a different axial width than odd teeth of the chainring. Hence, the chainring includes alternatingly teeth having a first axial width and teeth having or second axial width. This may aid in maintaining the chain properly positioned on the single chainring.

Optionally, the bicycle drivetrain system 1 is configured to provide, at least selectively, a smallest gear ratio from the crankset 8 via the cogset 4 and the transmission assembly 14 of at most about 2.1.

For example, a gear ratio of about 2.07 can be provided by a combination of a chainring circumference C of 58 times the minimal interteeth distance D, a sprocket circumference S of 28 times the minimal interteeth distance D, and a transmission assembly transmission ratio of unity.

Optionally, the bicycle drivetrain system 1 is configured to provide a range of selectable gear ratios from the crankset 8 via the cogset 4 and the transmission assembly 14, the range having an upper limit of less than 6, preferably less than 5.50, for example about 5.

Optionally, the bicycle drivetrain system is configured to provide a range of selectable gear ratios from the crankset 8 via the cogset 4 and the transmission assembly 14, the range having a lower limit of more than 1, preferably more than 1.5, for example about 2.

Optionally, with reference to the example shown in FIG. 5B discussed above, for at least one sprocket 5 of the plurality of sprockets 5 of the cogset 4, a mutual interspacing Ts of subsequent ones of the respective sprocket teeth 6 along the sprocket circumference S corresponds to an integer multiple of the minimal interteeth distance D, for example double the minimal interteeth distance D, preferably along the entire sprocket circumference S.

Optionally, with reference to the example shown in FIG. 6B discussed above, for the chainring 9, a mutual interspacing Tc of subsequent ones of the respective chainring teeth 10 along the chainring circumference C corresponds to an integer multiple of the minimal interteeth distance D, for example double the minimal interteeth distance D, preferably along the entire chainring circumference C.

Optionally, the cogset 4 is free from any sprocket having less than twelve respective sprocket teeth, so that each sprocket 5 of the plurality of sprockets 5 of the cogset 4 has at least twelve respective sprocket teeth 6.

Optionally, with reference to FIG. 3, the plurality of sprockets 5 of the cogset 4 together define an axial range R for the bicycle chain 7 at the cogset 4, said axial range R being less than or equal to 35 mm.

In FIG. 3, it can be seen that the laterally outermost sprockets 5 of the cogset can thus be laterally relatively close to a lateral position of the chainring 9, said lateral position being indicated in FIG. 3 by a distance L from a center line Y of the frame 12 of the bicycle. It shall be understood that this distance L may be relatively large for relatively large chainrings, so as to avoid collision between the chainring 9 and the frame 12, e.g. at the chain stay. A limited lateral range R of the cogset 4, for example associated with a limited number of sprockets 5, can then advantageously enable that first and second chain angles α₁ and α₂ corresponding to the outermost sprockets 5 can still be relatively small, thereby promoting power transfer efficiency, in particular at the cogset 4. It shall be appreciated that this advantageous effect can be increased further by further limiting the lateral range R, for example by (further) limiting the number of sprockets 5 and/or by reducing an axial width of one or more individual sprockets 5.

As shown in FIGS. 1 and 2, the bicycle drivetrain system 1 includes a gear change mechanism, generally indicated by reference sign 11 in FIGS. 1 and 2.

In the examples, the gear change mechanism 11 comprises a movable chain guide which is operable to transfer the bicycle chain 7 between different sprockets 5 of the cogset 4.

Here, the gear change mechanism 11 comprises a derailleur assembly, such as a clutch derailleur assembly. The gear change mechanism 11 can comprises an electronic gear change device, in particular for and/or comprising an electronic derailleur gear change device. The hub gear assembly 14 and the electronic gear change device can be controlled wiredly and/or wirelessly, e.g. from a control unit, such as mounted to the bicycle handlebars.

Although the examples show a single chainring 9, it will be appreciated that the bicycle drivetrain system can include a crankset including one or more chainrings, of which at least one chainring is as described herein.

The figures also variously illustrate a method of modifying a drivetrain 3 of a bicycle 2, for example a road bicycle 2. The method comprises replacing a cogset 4 and/or a crankset 8 of the drivetrain 3.

If the drivetrain to be modified comprises a first cogset which comprises at least one sprocket whose sprocket circumference corresponds to less than twelve times a minimal interteeth distance D defined by a bicycle chain 7 of the drivetrain, the method comprises replacing the first cogset by a second cogset 4. The second cogset 4 comprises a plurality of sprockets 5, wherein a smallest respective sprocket circumference S of any sprocket 5 of the second cogset 4 corresponds to at least twelve times the minimal interteeth distance D.

If the drivetrain to be modified comprises a first crankset which is free from any chainring whose chainring circumference corresponds to at least 58 times the minimal interteeth distance D, the method comprises replacing the first crankset by a second crankset 8. The second crankset 8 comprises at least one chainring 9 whose chainring circumference C corresponds to at least 58 times the minimal interteeth distance D.

While the invention has been explained using exemplary embodiments and drawings, these do not limit the scope of the appended claims. For the purpose of clarity and a concise description features are described herein as part of the same or separate embodiments, however, it will be appreciated that the scope of the invention may include embodiments having combinations of all or some of the features described. Many alternatives, variations and extensions are possible as will be readily understood by the skilled person. For example, a crankset may comprise multiple chainrings.

In the claims, any reference sign placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A bicycle drivetrain system for a road bicycle, comprising:
a transmission assembly including at least one of a hub gear assembly and/or a crank gear assembly having at least two selectable transmission ratios; and further:
a single chainring having chainring teeth for engagement with a bicycle chain which defines a minimal interteeth distance, the chainring teeth being arranged along a chainring circumference; and
a cogset comprising a plurality of sprockets each having respective sprocket teeth for engagement with the bicycle chain, the sprocket teeth being arranged along a respective sprocket circumference,
wherein a smallest respective sprocket circumference of any such sprocket of the cogset corresponds to at least twelve times the minimal interteeth distance.

2. The bicycle drivetrain system of claim 1, wherein the transmission assembly includes a speed reducing transmission ratio.

3. The bicycle drivetrain system of claim 1, wherein the transmission assembly includes a speed increasing transmission ratio.

4. The bicycle drivetrain system of claim 1, wherein, the single chainring has a chainring circumference corresponding to at least 54 times the minimal interteeth distance.

5. (canceled)

6. (canceled)

7. The bicycle drivetrain system of claim 1, wherein the single chainring has a chainring circumference corresponding to an even multiple of the minimal interteeth distance wherein even teeth of the single chainring have a different axial width than odd teeth of the single chainring.

8. (canceled)

9. The bicycle drivetrain system according to claim 1, configured to provide, at least selectively, a largest gear ratio from a crankset to the cogset of at least 4.83.

10. The bicycle drivetrain system according to claim 1, configured to provide, at least selectively, a smallest gear ratio from a crankset to the cogset of at most 2.1.

11. The bicycle drivetrain system according to claim 1, configured to provide a range of selectable gear ratios from the single chainring to the cogset and via the transmission assembly, the range having an upper limit of less than 6.

12. The bicycle drivetrain system according to claim 1, configured to provide a range of selectable gear ratios from the single chainring to the cogset and via the transmission assembly, the range having a lower limit of more than 1.

13. (canceled)

14. The bicycle drivetrain system according to claim 1, wherein the transmission assembly includes a planetary gear set and/or a continuously variable transmission.

15. (canceled)

16. The bicycle drivetrain system according to claim 1, wherein, a mutual interspacing of subsequent ones of the respective chainring teeth along the chainring circumference corresponds to an integer multiple of the minimal interteeth distance, for example double the minimal interteeth distance, preferably along at least a part of the entire chainring circumference.

17. (canceled)

18. The bicycle drivetrain system according to claim 1, wherein, for at least one sprocket of the plurality of sprockets of the cogset, a mutual interspacing of subsequent ones of the respective sprocket teeth along the sprocket circumference corresponds to an integer multiple of the minimal interteeth distance, for example double the minimal interteeth distance, along at least a part of the sprocket circumference.

19. (canceled)

20. The bicycle drivetrain system according to claim 1, wherein the plurality of sprockets of the cogset together define an axial range for the bicycle chain at the cogset, said axial range being less than or equal to 36 mm.

21. The bicycle drivetrain system according to claim 1, wherein a number of sprockets of the plurality of sprockets of the cogset is less than or equal to ten.

22. The bicycle drivetrain system according to claim 1, wherein a number of sprockets of the plurality of sprockets of the cogset is less than or equal to ten and axial spacing between cogs is less than 3.7 mm.

23. The bicycle drivetrain system according to claim 1, comprising an electronic gear change device configured for changing a transmission ratio of the transmission assembly and/or selecting a sprocket of the cogset.

24. The bicycle drivetrain system according to claim 1, wherein the single chainring forms a closed surface from a spindle towards the teeth.

25. The bicycle drivetrain system according to claim 24, wherein the closed surface is arranged to be personalized.

26. The bicycle drivetrain system according to claim 24, wherein the closed surface can be removed from the spindle without disassembling crank-arms.

27. The bicycle drivetrain system according to claim 24, comprising a cover covering the closed surface, and the cover can be removed without disassembling the single chainring.

28. The bicycle drivetrain system according to claim 1, further comprising the bicycle chain, wherein the bicycle chain is engaged with one of the plurality of sprockets of the cogset as well as with the single chainring.

29. (canceled)

30. A bicycle comprising the bicycle drivetrain system according to claim 1.

31. (canceled)
